(19) United States
(12) Patent Application Publication
(10) Pub. No.: US 2009/0071653 A1
(43) Pub. Date: Mar. 19, 2009

(54) COMPOSITION AND METHOD FOR CLEANING FORMATION FACES

(75) Inventor: KENNETH DWAYNE HODGE, Red Deer (CA)

Correspondence Address: DENNIS T. GRIGGS, 17950 PRESTON ROAD, SUITE 1000, DALLAS, TX, 75252, US

(73) Assignee: Ramtha Energy Solutions Inc., Peachland (CA)

(21) Appl. No.: 12/115,997

(22) Filed: May 6, 2008

(30) Foreign Application Priority Data
Sep. 14, 2007 (CA) 2602746

(51) Int. Cl. E21B 37/06; C09K 8/52

(52) U.S. Cl. 166/311; 507/90

(57) ABSTRACT

A composition for preventing or removing the build-up of a fluid film on a target surface of wells, processing equipment or geological formations and a method of using same is provided. The composition can be non-aqueous and alkaline and can include sodium carbonate, sodium phosphate tribasic, sodium hydroxide and sodium metasilicate. The method includes preparing the composition and then delivering the composition to the target surface. The composition can further include a non-aqueous carrier and/or a pH buffer.

### CROSS REFERENCE TO FOREIGN PRIORITY APPLICATION

Priority is claimed under 35 U.S.C. §119 to Canadian Application No. 2,602,746 entitled “Composition and Method for Cleaning Formation Faces” filed Sep. 14, 2007 by Kenneth Dwayne Hodge.

### BACKGROUND OF THE INVENTION

1. Field of the invention

The present disclosure relates to compositions and methods for removing or preventing the build-up of geological formation film on wells, on processing equipment or on geological formations.

2. Description of the related art

When a well bore is drilled into a hydrocarbon bearing geological formation, hydrocarbon substances flow into the well bore from the formation. As hydrocarbon substances flow into the well bore, fluid film can build up on the geological formation face. This film build-up can impede further inflow of substances into the well bore.

The fluid film can comprise one or more of the following: scale, undissolved solids, asphaltenes (asphaltines), paraffins, tars, oils, wax and other viscous constituents. Efficient hydrocarbon recovery is inhibited by the build-up of fluid film in wells, on the processing equipment associated with gas and oil recovery and processing and on geological formations.

In injection wells, asphaltenes, paraffins and heavy hydrocarbons from producing wells, that passed re-injection water filtration can combine with scale (from produced water) along with other fluid film to clog the geological formation and thereby impede injection flow rates into injection wells.

The native water of a geological formation is water that is already associated with the geological formation prior to any other substance being introduced by man into the formation. Water, whether native or subsequently introduced, as injection treated water, can cause swelling of the clays, silts, carbonates and other components comprising the geological formation. In a producing well, this swelling can contribute to impeding the flow of hydrocarbons flowing into the well bore. The swelling can also reduce the water injection rate of an injection well. This swelling can also result in skin damage to the geological formation face.

Acidic cleaners can be used to remove the build-up of fluid film. In doing so, these cleaners can dissolve some of the geological formation face thus forming filter cake. This filter cake can further reduce the permeability of the formation and, hence, the injection flow rate of an injection well or the yield of a producing well.

For the purposes of this specification, the wetability of a solid (such as the matrix of a geological formation) relates to the tendency of preferred adherence between the solid and a particular type of fluid, the type of fluid being termed a wetting agent. The wetting agent forms a wetting phase that displaces a non-wetting phase from contact with the target surface of a solid. For example, where the wetting agent is water, the water-wet solid will preferably contact and imbibe water to the exclusion of a non-wetting phase, for example, oil. Sandstones and carbonates tend to be water-wet before contact with crude oil, but may be altered by components of the crude oil to become oil-wet. Where the wetting agent is oil, an oil-wet solid will preferably contact and imbibe oil to the exclusion of a non-wetting phase, for example, water. For example, via polar attraction, polar compounds or asphaltenes deposited from crude oil or oil-base mud onto mineral surfaces can cause an oil-wet condition.

Wetting agents can affect the permeability of a geological formation. For example, in a geological formation that has produced oil for a period of time, some of the produced oil may interact with the geological formation so that the oil acts as a wetting agent to limit the geological formation's permeability to water. The oil acting as a wetting agent can thus limit the subsequent reinjection of water into the geological formation as a means for stimulating production from the formation.

Stimulation (or “workover”) of a hydrocarbon well is performed in order to enhance, stimulate or prolong hydrocarbon production from the well. In certain examples, a well can be stimulated by being perforated, fractured (“fracing”), acidized, squeezed or flushed.

The first workover of a newly drilled well is termed “completion.” To complete a newly drilled well, production casing is run by the drilling rig and cemented in place. The drilling rig is removed and a wellhead is secured to the production casing. The casing can then be perforated at set depth intervals using explosives to access the different production zones of the formation. A workover to complete a well into a different production zone is termed a re-completion.

A geological formation is fractured (“fraced”) to stimulate, enhance or prolong hydrocarbon production from the geological formation. Fracturing involves pumping hydraulic fluids into the geological formation at sufficient pressure to fracture a targeted region of the geological formation. Fracturing can create high-permeability pathways at these targeted regions through which hydrocarbons can flow into the well bore. Removing fluid film from these high-permeability pathways further promotes the flow of hydrocarbons through these pathways.

It is, therefore, desirable to provide compositions and methods for cleaning or removing fluid film build-up from the formation face to enhance hydrocarbon production.

### BRIEF SUMMARY OF THE INVENTION

A method is provided for preventing or removing the build-up of a fluid film from a target surface on the formation face of wells, processing equipment or geological formations in order to increase the capacity of the well, equipment or formation and to promote the flow of water and/or of hydrocarbons. In one embodiment, the method can comprise the steps of: a) preparing a composition that comprises an effective amount of a surfactant, an effective amount of an abrasive agent, an effective amount of a caustic agent and an effective amount of an anti-caking agent; and b) delivering the composition to the target surface. In another embodiment, the composition can be both non-aqueous and alkaline. In another embodiment, the composition can be mixed with a non-aqueous carrier into a mixture whereby the mixture is delivered to the target surface to prevent or remove the build-up of said fluid film on said target surface.

In other embodiments, this method can be used to prevent or reduce the swelling of a geological formation; to prevent or reduce skin damage on a target surface of a geological formation; and to alter the wetability of a target surface on a geological formation.

In another embodiment, a method is provided for preventing or removing the build-up of a fluid film from a geological formation whereby the capacity of said geological formation and the ability of water and/or hydrocarbons to flow can be increased. The method can comprise the steps of: a) preparing a composition that comprises an effective amount of a surfactant, an effective amount of a abrasive agent, an effective amount of a caustic agent and an effective amount of an anti-caking agent; b) creating at least one fracture in the formation; and c) delivering the composition to the at least one fracture. In another embodiment, the composition can be both non-aqueous and alkaline. In a further embodiment, the composition can be mixed with a non-aqueous carrier into a mixture whereby the mixture is delivered to the target surface to prevent or remove the build-up of said fluid film on said target surface.

In one embodiment, the fracture can be created by delivering an effective amount of hydraulic fluid under sufficient pressure to a targeted level of said geological formation to create a fracture in the formation. In a further embodiment the composition can be delivered into the fracture by injection under pressure whereby the composition can be left in the fracture until the composition has become depleted.

In one embodiment, the composition can comprise sodium carbonate [Na₂CO₃], sodium phosphate tribasic [(NaO)₃PO₄], sodium hydroxide [NaOH], and sodium metasilicate [Na₂SiO₃]. In a further embodiment, the composition can comprise a pH buffer. The pH buffer can comprise sodium hydroxide or sodium carbonate. In other embodiments, the pH buffer can comprise any suitable alkali metal hydroxide or any suitable alkali metal carbonate as obvious to those skilled in the art.

In one embodiment, the composition can be mixed with a non-aqueous carrier to form a mixture whereby the composition can be delivered in this mixture to a target surface as defined above. In another embodiment, the mixture can be delivered into the fracture by injection under pressure whereby the mixture can be left in the fracture until the mixture has become depleted. In another embodiment, the non-aqueous carrier can comprise hydrocarbons. In yet another embodiment, a phosphoric ester gelling agent or a non-phosphoric gelling agent as known to those skilled in the art can be used to gel the non-aqueous carrier.

### DETAILED DESCRIPTION OF THE INVENTION

A method is provided for helping to prevent or to remove the build-up of a fluid film from association with a target surface in order to increase the capacity of said well and to promote the flow of water and/or of hydrocarbons. For the purposes of this specification, the target surface can include surfaces of a well, surfaces within or on any processing equipment used in the handling of produced hydrocarbons or fluids pumped out or into a well or surfaces of a geological formation including, but not limited to, fractures created in the formation.

In one embodiment, the method can comprise the steps of: a) preparing a composition that comprises an effective amount of a surfactant, an effective amount of a abrasive agent, an effective amount of a caustic agent and an effective amount of an anti-caking agent; and b) delivering the composition to the target surface.

In another embodiment, the composition can be both non-aqueous and alkaline. In a further embodiment, the composition can be mixed with a non-aqueous carrier to form a mixture that is delivered to the target surface. The ratio of composition to non-aqueous carrier and the amount of the mixture introduced will depend on the amount and type of fluid film that is associated with the target surface and can be easily determined by a person skilled in the art.

In one embodiment, pressure can be applied to force said composition through the perforations of a well and into the geological formation. After the composition is delivered to the target surface so as to at least partially coat the target surface, the composition can contact the fluid film to remove it or to prevent further build-up of fluid film on the target surface.

In another embodiment, the composition can be delivered under applied pressure into the geological formation surrounding a well so that the composition can permeate the geological formation and at least partially remove blockages in the geological formation to help provide more efficient oil and gas recovery. The size of the target surface area to be cleaned or protected as well the anticipated amount and nature of the fluid film are factors in determining the exact dosage needed. The example set out below describes a basic initial dosage of 500 kg of the composition mixed with 820 L of a non-aqueous gelling agent carrier for use in a 950 meter deep well.

In further embodiments, the methods described above can be repeated on a periodic basis throughout the life of the well. The frequency of treatment required can be dictated by the characteristics and extent of fluid film build-up on the target area.

As noted above, pressure can be applied to the composition to force it through the perforations of said well and into said geological formation to prevent or remove the build-up of a fluid film from the target surface of a geological formation. In this embodiment, the method comprises the steps of: a) preparing a composition that comprises an effective amount of a surfactant, an effective amount of a abrasive agent, an effective amount of a caustic agent and an effective amount of an anti-caking agent; b) creating at least one fracture in the formation; and c) delivering the composition to the at least one fracture.

In this embodiment, the fracture can be created by delivering an effective amount of hydraulic fluid to a targeted level of the geological formation under sufficient pressure to create a fracture in the geological formation. In another embodiment, the composition can be mixed with a non-aqueous carrier to form a mixture before being delivered to the fracture. The mixture can be forced into the target location of the geological formation by any one of a variety of methods. In certain embodiments, such methods can include carbon dioxide injection, nitrogen injection, gelled hydrocarbon injection and sand/slurry injection.

In another embodiment, proppants can be used when the geological formation is fractured in order to prevent induced fractures from closing completely after pressure is released. In one embodiment, a proppant can be delivered into a fracture by injection under pressure during or after delivery of the mixture or of the composition. Proppants of different mesh size can sometimes be used during the fracturing process. For example, the initial proppant used at the start of the fracturing process can have a smaller mesh size than a propant used later in the fracturing process. In one embodiment, the granules of the composition can be equal to or smaller in size than the mesh size of the proppant or of the initial proppant.

As described above, the composition can comprise a surfactant, an abrasive agent, a caustic agent and an anti-caking agent. In another embodiment, the composition can comprise a pH buffer. In one embodiment, the surfactant can comprise sodium carbonate [Na₂CO₃]. In another embodiment, the abrasive agent can comprise sodium phosphate tribasic [(NaO)₃PO₄]. In a further embodiment, the caustic agent can comprise any suitable alkali metal hydroxide as known to those skilled in the art. In one embodiment, said caustic agent comprises sodium hydroxide [NaOH]. In yet another embodiment, the anti-caking agent can comprise sodium metasilicate [Na₂SiO₃]. In other embodiments, the pH buffer can comprise any suitable alkali metal hydroxide as known to those skilled in the art. In further embodiments, the pH buffer can comprise any suitable alkali metal carbonate as known to those skilled in the art. In yet further embodiments, the pH buffer can comprise sodium hydroxide [NaOH] and/or sodium carbonate [Na₂CO₃].

In one embodiment, the composition, as used in the methods described herein, can comprise sodium carbonate, sodium phosphate tribasic, sodium hydroxide and sodium metasilicate. In certain embodiments, the composition can comprise, by weight, about 45% to 55% sodium carbonate, about 35% to 45% sodium phosphate tribasic, about 5% sodium hydroxide and about 5% sodium metasilicate. In a representative embodiment, the composition can comprise, by weight, about 50% sodium carbonate, about 40% sodium phosphate tribasic, about 5% sodium hydroxide and about 5% sodium metasilicate.

In certain embodiments of the methods described herein, the composition once delivered at the target surface, can interact with water in the geological formation to help reduce or prevent the swelling of the geological formation.

In certain embodiments of the methods described herein, the composition, once delivered at the target surface, can interact with the native water of the geological formation to help reduce or prevent the swelling of the geological formation.

In certain embodiments of the methods described herein, the composition, once at the target surface, can interact with the native water of the geological formation to help reduce or prevent skin damage to the face of the geological formation.

In certain embodiments of the methods described herein, the composition, once at the target surface, can alter the wetability of the target surface in order to increase the capacity of the well or to promote the flow of water or of hydrocarbons through the formation.

In certain embodiments of the methods, the non-aqueous carrier that can be mixed with the composition described herein can comprise nitrogen, carbon dioxide or a fracturing fluid (which can also be referred to “frac oil”). In these embodiments, the non-aqueous carrier can be used as a viscosity index booster.

In one embodiment, the non-aqueous carrier can be liquid nitrogen [N₂] as provided by Ferus Gas Industries Inc., having the UN Number (PIN): UN 1977. In a further embodiment, the non-aqueous carrier can comprise a nitrogen gel that can be used for sweet natural gas geological formation fractures.

In another embodiment, the non-aqueous carrier can comprise liquefied carbon dioxide [CO₂] as prepared by ChemErgy Ltd. for CalFrac Well services, and having the UN Number (PIN): UN 2187. In a further embodiment, the non-aqueous carrier can comprise a carbon dioxide gel that can be used for miscible flood geological formation fractures.

In one embodiment, the non-aqueous carrier can comprise a fracturing fluid. The fracturing fluid can comprise mostly hydrocarbons plus small amounts of benzene, ethylbenzene, toluene and xylene. In one embodiment, the fracturing fluid and comprise hexanes, heptanes, octanes, nonanes, tolulene, ethyl benzene, xylene, 1,2,4-trimethylbenzene, methyl cyclopentane, cyclohexane, methyl cyclohexane and benzene. One suitable fracturing fluid is provided by Frac Solutions Ltd. and has the UN Number (PIN) 1268. In one embodiment, the fracturing fluid can be TR50 provided by BP Canada Energy Company having the UN Number (PIN) 1268. TR 50 comprises: natural gas condensates (petroleum), pentane, n-hexane, butane, cyclohexanes, benzene, n-heptance, methylcycohexanes and toluene. In another embodiment, the fracturing fluid can comprise reformate, also known as napthaline (chemical formula C₁₀H₈). In one embodiment, reformate can be used to fracture waxy or heavy oil-bearing geological formations. In one embodiment, gelled fracturing fluid can be used to fracture oil bearing geological formation.

In other embodiments, the non-aqueous carrier can comprise hydrocarbons and can be combined with a gelling agent. It is obvious to those skilled in the art that any suitable phosphoric ester gelling agent can be used in the non-aqueous carrier. It is also obvious to a person skilled in the art that non-phosphoric gelling agents can also be used in the non-aqueous carrier.

### EXAMPLE

In the following example, the relative effectiveness of the method was determined in a cleaning application.

Three injection wells, having an average well depth of 950 meters, were experiencing problems with deposit build-up and consequential reduced injection capacity. In these wells, geological formation fluid film (comprising ashphaltines, wax and heavy hydrocarbons that passed filtration) combined with scale (from produced water) to form a fluid film that clogged the geological formation and thereby impeded injection into these wells.

In order to unclog these wells, each well was treated with the below composition in accordance with the following treatment:

(a) a composition was prepared comprising the following chemicals (by weight):

about 50% Sodium Carbonate [Na₂CO₃]

about 40% Sodium Phosphate Tribasic [(NaO)₃PO₄]

about 5% Sodium Hydroxide [NaOH]

about 5% Sodium Metasilicate [Na₂SiO₃]

(b) for each well, 500 kg of the composition was blended with 820 litres of non-aqueous carrier to form a mixture; and

(c) the mixture was delivered to specific areas located at the perforation of the well in a selective squeeze and pumped into the geological formation at a pressure just below geological formation fracture pressure.

The mixture was pressure pumped through coil tubing into specific target locations of the geological formation targeted for stimulation. A hot oil unit supplied the pumping pressure required for this injection. The average required pumping pressure for injection of the mixture was just less than 13,800 kPa.

This mixture had a temperature of about 5° C. just before it was injected from the surface into the geological formation. The average geological formation temperature at the site of surface injection was about 31° C. Once delivered, the mixture was left to remain in the geological formation until depletion of the mixture. Following the delivery of the mixture, each well was returned to injection status and monitored for pressure and volume variations.

The treatment caused the injection pressure to decline. Before treatment, only about 45% of the produced water coming from this oilfield could be returned to this same oilfield. The remaining produced water had to be shipped elsewhere for disposal. Before treatment, only one out of six pumps in the oil field was operating for disposal of the produced water. Before treatment, this one operating pump was discharging at a maximum pressure of about 13,800 kPa for disposal of the produced water. At about 10 days after treatment, pump pressure discharge had dropped to about 4,050 kPa.

Before treatment, and with only the one pump applied, the average initial wellhead injection pressure of the sixteen injection wells was about 12,400 kPa. At about 10 days after treatment, the wellhead injection pressure had dropped to about 1,090 kPa. The inventor believes that the decreased injection pressure is attributable to the removal of fluid film and to the prevention fluid film build-up from target surfaces of the geological formation caused by the application of the treatment described above thereby allowing produced water to enter the geological formation. By about 10 days following treatment, the average injection capacity of the three treated wells had increased until the majority of produced water from a sixteen well injection was entering these three treated injection wells.

After treatment, all six pumps were returned to service. All of the produced water from this oil field could be returned to this same oilfield. Not only did these treated wells accept the majority of in house injection, the increased injection capacity of these treated wells made it possible to inject and dispose of additional produced water coming from a different oilfield.

Also as a result of the treatment, the remedial fracture interval was extended by about 22% resulting in lower workover costs. The increased injection capacity obtained in the three treated wells resulted in increased sustained oil production of between about 4% to about 15% on the pattern. In contrast, negligible results were recorded from earlier attempts in the water flood pattern.

The foregoing provides one embodiment of a method for cleaning fluid film from geological formations in order to unclog geological formations and to improve the injection capacity of wells. The fluid film in injection wells has the comparable constituents as fluid film in producing wells so the inventor believes that the method and composition disclosed herein is comparably useful in cleaning hydrocarbon-producing wells.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

1. A method for preventing or removing the build-up of a fluid film from a target surface, the method comprising the steps of:
a) providing a composition, comprising:
i) an effective amount of a surfactant,
ii) an effective amount of an abrasive agent,
iii) an effective amount of a caustic agent, and
iv) an effective amount of an anti-caking agent; and
b) delivering the composition to the target surface where the composition can contact the fluid film.

2. The method as set forth in claim 1 wherein the target surface is disposed on a formation face of a well, on processing equipment or on a geological formation comprising at least one fracture.

3. The method as set forth in claim 2 further comprising the step of applying pressure on the composition as it is being delivered to the target surface so as to force the composition into the at least one fracture.

4. The method as set forth in claim 1 further comprising the step of mixing the composition with a non-aqueous carrier before delivering the composition to the target location.

5. The method as set forth in claim 2 wherein the method prevents or reduces the swelling of the target surface on the geological formation.

6. The method as set forth in claim 2 wherein the method prevents or reduces skin damage of the target surface on the geological formation.

7. The method as set forth in claim 2 wherein the method alters the wetability of the target surface on the geological formation.

8. The method as set forth in claim 2 further comprising the step of creating at least one fracture in the geological formation whereby the composition is delivered to the at least one fracture.

9. The method as set forth in claim 8 wherein the step of creating the at least one fracture further comprises delivering an effective mount of hydraulic fluid to the geological formation under sufficient pressure the create the at least one fracture.

10. The method as set forth in claim 9 further comprising the step of delivering an initial proppant before delivering the composition into the at least one fracture or delivering a proppant into the at least one fracture by injection under pressure after delivering the composition into the at least one fracture.

11. The method as set forth in claim 10 wherein the composition is comprised of granules that are equal the or smaller in size than the mesh size of the proppant or of the initial proppant.

12. The method as set forth in claim 8 further comprising the step of mixing the composition with a non-aqueous carrier before delivering the composition to the at least one fracture.

13. The method as set forth in claim 1 wherein the surfactant comprises sodium carbonate.

14. The method as set forth in claim 1 wherein he abrasive agent comprises sodium phosphate tribasic.

15. The method as set forth in claim 1 wherein the caustic agent comprises an alkali metal hydroxide.

16. The method as set forth in claim 1 wherein the anti-caking agent comprises sodium metasilicate.

17. The method as set forth in claim 1 wherein the composition further comprises a pH buffer.

18. The method as set forth in claim 17 wherein the pH buffer comprises one or more of the group consisting of alkali metal hydroxides and alkali metal carbonates.

19. The method as set forth in claim 13 wherein the composition comprises about 45% the 55% sodium carbonate by weight.

20. The method as set forth in claim 14 wherein the composition comprises about 35% the 45% sodium phosphate tribasic by weight.

21. The method as set forth in claim 15 wherein the composition comprises about 5% sodium hydroxide by weight.

22. The method as set forth in claim 16 wherein the composition comprises about 5% sodium metasilicate weight.

23. The method as set forth in claim 4 wherein the non-aqueous carrier comprises one or more of the group consisting of nitrogen, carbon dioxide and a fracturing fluid.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
